(19) United States
(12) Patent Application Publication
(10) Pub. No.: US 2023/0273377 A1
(43) Pub. Date: Aug. 31, 2023

(54) FERRULE FOR OPTICAL CONNECTOR AND OPTICAL CONNECTOR

(71) Applicant: Fujikura Ltd., Tokyo (JP)

(72) Inventor: Takaaki Nakane, Sakura-shi (JP)

(73) Assignee: Fujikura Ltd., Tokyo (JP)

(21) Appl. No.: 18/016,807

(22) PCT Filed: Apr. 20, 2021
(86) PCT No.: PCT/JP2021/016005

§ 371 Date: Jan. 18, 2023

(30) Foreign Application Priority Data
Oct. 7, 2020 (JP) 2020-169710

(51) Int. Cl. G02B 6/38

(52) U.S. Cl. CPC G02B 6/3886; G02B 6/3882

(57) ABSTRACT

A ferrule for an optical connector includes: a body portion including a fiber hole through which a first optical fiber is inserted, a connection end face at which the fiber hole opens, and a substance, within the body portion, that generates a magnetic force. The body portion is configured to optically connect the first optical fiber to a second optical fiber by the magnetic force.

### TECHNICAL FIELD

The present invention relates to a ferrule for an optical connector and an optical connector.

Priority is claimed on Japanese Patent Application No. 2020-169710, filed Oct. 7, 2020, the content of which is incorporated herein by reference.

### BACKGROUND

Patent Document 1 discloses a configuration in which ferrules of a pair of optical connectors are abutted against one another with a clip. Each ferrule has a fiber hole through which an optical fiber is inserted through. Since the ferrules are abutted against one another by the pressing force generated by the clip, the optical fibers of a pair of optical connectors are optically connected to one another.

### PATENT LITERATURE

[Patent Document 1] U.S. patent application, Publication No. 2017/0199337

In the configuration of Patent Document 1, the clip rubs against the ferrule each time the optical connectors are attached to or detached from one another. This may have resulted in cases where wear of the ferrule occurred.

### SUMMARY

The present invention has been made in consideration of the above circumstances, and provides a ferrule for an optical connector or an optical connector capable of suppressing abrasion of the ferrule when the optical connectors are attached to or detached from one another.

According to one or more embodiments of the present invention, a ferrule for an optical connector includes a body portion including a fiber hole through which an optical fiber is inserted through, a connection end face at which the fiber hole opens, and a substance that generates a magnetic force therein, in which the body portion is configured to optically connect the first optical fiber to a second optical fiber by the magnetic force.

According to one or more embodiments, the ferrules of a pair of optical connectors are able to be attracted to one another by a magnetic force. In this way, by abutting the connection end faces of the ferrules against one another using a magnetic force, it is possible to suppress abrasion of the ferrules compared to the case where a clip or the like is used, for example

According to one or more embodiments of the present invention, in the ferrule for an optical connector according to the embodiments described above, the body portion may be formed of a material containing a hard magnetic filler, and the hard magnetic filler may be the substance, and the magnetic force may act on the connection end face.

According to one or more embodiments of the present invention, an optical connector includes the ferrule for an optical connector according to the embodiments described above; the first optical fiber inserted through the fiber hole; and a guide pin, in which the body portion may include a guide hole that extends along an axial direction of the fiber hole and opens at the connection end face, and the guide pin may be inserted through the guide hole, may protrude from the connection end face, and may be formed of a non-magnetic material.

According to one or more embodiments of the present invention, in the ferrule for an optical connector according to the embodiments described above, the body portion may include a guide hole for a guide pin, the guide hole that extends along an axial direction of the fiber hole and opens at the connection end face, and an accommodating portion in which the substance is accommodated, and the substance may be a permanent magnet.

According to one or more embodiments of the present invention, in the ferrule for an optical connector according to the embodiments described above, the body portion may be formed of a material containing a hard magnetic filler or a soft magnetic filler.

According to one or more embodiments of the present invention, an optical connector, includes: the ferrule for an optical connector according to the embodiments described above; a guide pin that is inserted through the guide hole, protrudes from the connection end face, and is formed of a soft magnetic material; and a first optical fiber inserted through the fiber hole, in which when the connection end face side in the axial direction is defined as a front side and an opposite side of the connection end face side is defined as a rear side, the accommodating portion may be positioned to the rear side of the guide hole.

According to one or more embodiments of the present invention, it is possible to provide a ferrule for an optical connector or an optical connector that capable of suppressing abrasion of the ferrule when the optical connectors are attached to or detached from one another.

### BRIEF DESCRIPTION OF THE DRAWINGS

FIG. 1 is a perspective view of an optical connector according to first embodiments.

FIG. 2A is a diagram representing how optical connectors according to the first embodiments are connected to one another.

FIG. 2B is a diagram showing a step following FIG. 2A.

FIG. 3A is a diagram representing how optical connectors according to second embodiments are connected to one another.

FIG. 3B is a diagram showing a step following FIG. 3A.

### DETAILED DESCRIPTION

### First Embodiments

An optical connector and a ferrule for an optical connector according to the first embodiments is described below with reference to the drawings.

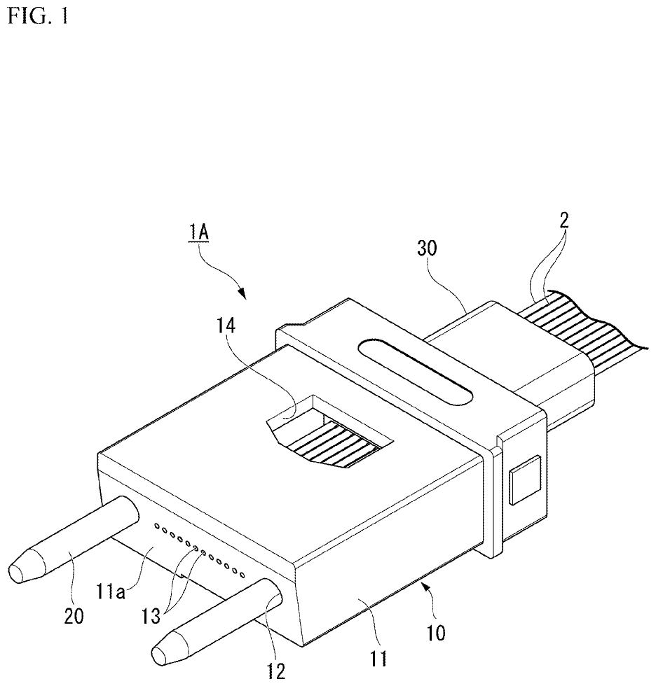

As shown in FIG. 1, an optical connector 1A includes a plurality of optical fibers 2, a ferrule 10 (ferrule for an optical connector), two guide pins 20, and a boot 30. The ferrule includes a body portion 11 formed with a plurality of fiber holes 13 through which the optical fibers 2 are inserted through. Two guide holes 12 are formed in the body portion 11. The body portion 11 has a connection end face 11a at which the fiber holes 13 and the guide holes 12 open.

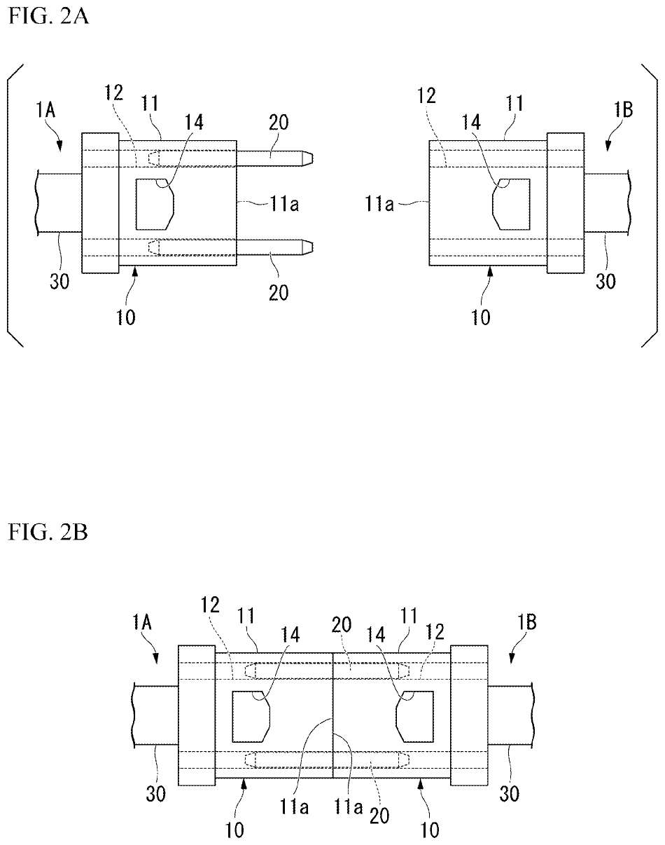

A guide pin 20 is inserted through each of the guide holes 12. The optical connector 1A in FIG. 1 is a male connector and has guide pins 20, whereas a female optical connector 1B (see FIG. 2A) does not include guide pins 20. By inserting the guide pins 20 of a male optical connector 1A through into the guide holes 12 of the female optical connector 1B, the ferrules 10 of the two optical connectors 1A and 1B are aligned with one another.

Hereinafter, the configuration of the male optical connector 1A used to represent the optical connectors 1A and 1B is explained. In other words, the following description also describes the female optical connector 1B. The female optical connector 1B may differ from the optical connector 1A only in that the guide pins 20 are not provided, or may differ in other aspects. In the male optical connector 1A, the guide pins 20 may be fixed by a pin clamp (a groove provided in the guide pin is held by a C-shaped clip) which is common, or may be fixed in the guide hole 12 by an adhesive. Alternatively, the guide pin 20 may be fixed to the guide hole 12 by another method (for example, press fitting the guide pin 20 into the guide hole 12).

### Definition of Directions

In one or more embodiments, the direction in which the fiber holes 13 extend is called an axial direction. Along the axial direction, the connection end face 11a side viewed from the ferrule 10 is referred to as a front side or a distal side, and the opposite side (the side from which the boot 30 extends) is referred to as a rear side or a proximal side. The direction in which the two guide holes 12 are arranged is referred to as a left-right direction. The left-right direction is orthogonal to the axial direction. A direction orthogonal to both the axial direction and the left-right direction is referred to as an up-down direction.

The two guide holes 12 are disposed so as to sandwich the plurality of fiber holes 13, and extend along the axial direction. In the example of FIG. 1, the number of optical fibers 2 is twelve, and the number of fiber holes 13 is also twelve. The fiber holes 13 are arranged in the left-right direction. However, the number of optical fibers 2 and fiber holes 13 may be changed appropriately, and may be one each. The end face of each of the optical fiber 2 is exposed at the connection end face 11a. For this reason, when the connection end faces 11a of the optical connectors 1A and 1B are abutted against one another, the end faces of the optical fibers 2 of the optical connectors 1A and 1B are brought into contact with or close to one another. Thereby, the optical fibers 2 are optically connected to one another. In order to suppress the generation of return light, the connection end face 11a may be inclined with respect to the up-down direction. The connection end face 11a having such an inclination may be formed by polishing the body portion 11.

A filling hole 14 is formed in the upper surface of the body portion 11 of the ferrule 10. The optical fiber 2 is fixed to the ferrule 10 by filling the inside of the body portion 11 with an adhesive or the like through the filling hole 14.

The boot 30 extends rearward from the ferrule 10. The boot 30 is formed in a cylindrical shape, and the optical fiber 2 is inserted through therein. A part of the optical fiber 2 which extends to the rear side from the boot 30 is covered with an outer skin (not shown).

Here, the body portion 11 of the ferrule 10 of one or more embodiments has therein a substance that generates a magnetic force. A more detailed description is given below.

The body portion 11 is formed by injection molding a material containing a base material such as resin and a hard magnetic filler. As the base material, Polyphenylenesulfide (PPS), nylon 6, nylon 12, or the like can be used. Other resins may be used as the base material. Powders such as neodymium-iron-boron (NdFeB), samarium-cobalt (SmCo), samarium-iron-nitrogen (SmFeN), and ferrite may be used as the hard magnetic filler. Other types of hard magnetic fillers may be used. Further, a plurality of types of hard magnetic fillers may be used in combination.

As the number of optical fibers 2 provided in the optical connectors 1A and 1B increases, a stronger magnetic force is required to maintain a good connection state. Therefore, for optical connectors 1A and 1B having 12 or 24 fibers, for example, neodymium-iron-boron (NdFeB) powder having a large magnetic force may be used as a hard magnetic filler.

A magnetic pole can be given to the ferrule 10 itself by carrying out a magnetizing step, after injection molding the body portion 11. The orientation of magnetization in the axial direction is made different between the ferrule 10 of the male optical connector 1A and the ferrule 10 of the female optical connector 1B. For example, when the connection end face 11a of the ferrule 10 of the optical connector 1A is an S pole, the connection end face 11a of the ferrule 10 of the optical connector 1B is magnetized to an N pole. Further, when the connection end face 11a of the ferrule 10 of the optical connector 1A is the N pole, the connection end face 11a of the ferrule 10 of the optical connector 1B is magnetized to the S pole.

FIGS. 2A and 2B are schematic diagrams showing how the optical connectors 1A and 1B are connected. In addition, in each figure in the following description, the shape of the ferrule 10 or the like is simplified and displayed.

When connecting the optical connectors 1A and 1B, as shown in FIG. 2A, the connection end faces 11a of the respective ferrules 10 are disposed to face one another. Then, the ferrules 10 are brought closer to each other, and the guide pins 20 of the optical connector 1A are inserted through into the guide holes 12 of the optical connector 1B. Thereby, the ferrules 10 of the optical connectors 1A and 1B are positioned. When the connection end faces 11a of the ferrules 10 are brought closer to each other, the ferrules 10 are attracted to one another by the magnetic force acting on the connection end faces 11a of one another.

A fiber hole 13 is opened in the connection end face 11a of each ferrule 10, and the end face of the optical fiber 2 is exposed in the fiber hole 13. The optical fibers 2 of the optical connectors 1A and 1B are optically connected by bringing the end faces of the optical fibers 2 into contact or close to each other, by abutting the connection end faces 11a against one another. Since the ferrules 10 are pressed against one another using an appropriate pressing force (magnetic force), the optical connection state is stabilized.

In addition, in one or more embodiments, the connection end faces 11a of the optical connectors 1A and 1B are attracted to one another by the magnetic force while being positioned by the guide pins 20 and the guide holes 12. However, the positioning method may be changed as appropriate. For example, when the ferrule 10 is cylindrical, the ferrules 10 may be positioned by fitting cylindrical members covering the ferrules 10. That is, the optical connectors 1A and 1B may not include the guide pin 20 and the guide hole 12.

As described above, the ferrule 10 of one or more embodiments includes the body portion 11 having the fiber hole 13 through which the optical fiber 2 is inserted through, and the connection end face 11a at which the fiber hole 13 opens. The body portion 11 has a substance (hard magnetic filler) that generates a magnetic force therein, and is configured to optically connect the optical fiber 2 to another optical fiber 2 by the magnetic force. Thus, the ferrules 10 of the optical connectors 1A and 1B are attracted to one another by the magnetic force. In this way, by abutting the connection end faces 11a of the ferrules 10 against one another using a magnetic force, it is possible to suppress abrasion of the ferrules compared to the case where a clip or the like is used, for example.

Further, the body portion 11 of one or more embodiments is formed of a material containing a hard magnetic filler, which is a substance that generates a magnetic force. Then, a magnetic force acts on the connection end face 11a. In this case, a magnetic force is able to be generated from the entire body portion 11, and the ferrules 10 of the optical connectors 1A and 1B is able to be attracted to one another with a stronger magnetic force. Therefore, the optical connection state between the optical fibers 2 becomes more stable.

Further, the optical connector 1A of one or more embodiments includes the ferrule 10, the optical fiber 2 inserted through the fiber hole 13, and the guide pin 20, the body portion 11 has the guide hole 12 that extends along the axial direction of the fiber hole 13 and opens at the connection end face 11a, and the guide pin 20 is inserted through the guide hole 12 and protrudes from the connection end face 11a. In such a configuration, the guide pin 20 may be formed of a non-magnetic material. In this case, it is possible to prevent the positioning of the ferrules 10 from becoming unstable due to the magnetic field or magnetic force generated by the guide pin 20. As the non-magnetic material forming the guide pin 20, for example, stainless steel (SUS303 or the like) may be used. In addition, a non-magnetic material other than stainless steel may be used as the guide pin 20.

However, the guide pin 20 may be a magnetic material. For example, it is possible to provide the guide pins 20 with SN polarity like a bar magnet such that the guide pins 20 do not interfere with the attraction between the ferrules 10 to one another, or so as to strengthen the attraction between the ferrules 10 to one another.

### Second Embodiments

Next, although second embodiments according to the present invention is described, the basic configuration is the same as that of the first embodiments. For this reason, the same reference numerals are given to similar components, the explanation thereof is omitted, and only the difference is described.

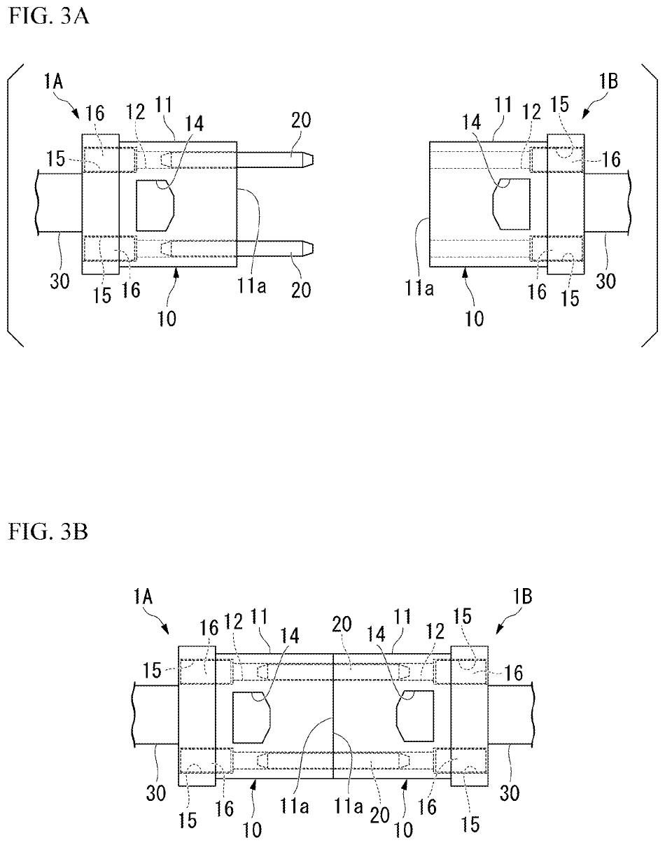

As shown in FIG. 3A, the optical connectors 1A and 1B of one or more embodiments each include two permanent magnets 16. The body portion 11 of the ferrule is formed with two accommodating portions 15 for accommodating the permanent magnets 16. Note that the number of accommodating portions 15 and permanent magnets 16 may be changed as appropriate, and may be one, or greater than or equal to three. The accommodating portion 15 is a concave portion recessed forward from the rear end of the body portion 11. The accommodating portion 15 is positioned to the rear side of the guide hole 12. In one or more embodiments, inside the body portion 11, the accommodating portion 15 and the guide hole 12 communicate with one another. However, the accommodating portion 15 and the guide hole 12 may not communicate with one another.

The width of the accommodating portion 15 in the left-right direction or the up-down direction is larger than that of the guide hole 12. For this reason, a step facing the rear side is formed inside the accommodating portion 15 at the connecting portion between the accommodating portion 15 and the guide hole 12. The contact of the permanent magnet 16 with the step prevents the permanent magnet 16 from entering into the guide hole 12. Also, the gap between the inner surface of the accommodating portion 15 and the permanent magnet 16 may be filled with an adhesive, and the permanent magnet 16 may be fixed with the adhesive. Alternatively, the permanent magnet 16 may be fixed by press fitting the permanent magnet 16 into the accommodating portion 15.

The guide pin 20 of one or more embodiments is formed of a soft magnetic material. Examples of a specific material of the soft magnetic material forming the guide pin 20 include SUS430. However, other types of soft magnetic materials may be used as the guide pins 20. Since the guide pin 20 is made of soft magnetic material, the guide pin 20 is magnetized by the permanent magnet 16. In FIG. 3A, the guide pin 20 and the permanent magnet 16 are axially separated. However, the guide pin 20 and the permanent magnet 16 may be in contact with one another. In this case, the permanent magnet 16 magnetizes the guide pin 20 more efficiently.

The specific material of the permanent magnet 16 is not particularly limited, and may be for example, a neodymium magnet, a samarium-cobalt magnet, an iron-platinum magnet, a ferrite magnet, or the like. As the number of optical fibers 2 provided in the optical connectors 1A and 1B increases, a stronger magnetic force is required to maintain a good connection state. Therefore, a neodymium magnet having a large magnetic force may be used as the permanent magnet 16 for the optical connectors 1A and 1B having 12 or 24 fibers, for example.

The orientation of the magnetic poles in the axial direction of the permanent magnet 16 differs between the male optical connector 1A and the female optical connector 1B. For example, when the magnetic pole of the permanent magnet 16 of the optical connector 1A on the side of the connection end face 11a is defined as the S pole, the magnetic pole of the permanent magnet 16 of the optical connector 1B on the side of the connection end face 11a is defined as the N pole. Further, when the magnetic pole of the permanent magnet 16 of the optical connector 1A on the side of the connection end face 11a is defined as the N pole, the magnetic pole of the permanent magnet 16 of the optical connector 1B on the side of the connection end face 11a is defined as the S pole.

When connecting the optical connectors 1A and 1B, as shown in FIG. 3A, the connection end faces 11a of the respective ferrules 10 are disposed to face one another. Then, the ferrules 10 are brought closer to each other, and the guide pins 20 of the optical connector 1A are inserted into the guide holes 12 of the optical connector 1B. Thereby, the ferrules 10 of the optical connectors 1A and 1B are positioned. The guide pin 20 is magnetized by the male permanent magnet 16. For this reason, when the guide pin 20 approaches the female permanent magnet 16, a magnetic force is generated between the guide pin 20 and the female permanent magnet 16. Since the guide pin 20 is fixed to the male ferrule 10, the ferrules 10 of the optical connectors 1A and 1B are attracted to one another by the magnetic force. Thereby, as shown in FIG. 3B, the connection end faces 11a of the ferrules 10 are brought into contact with one another.

A fiber hole 13 is opened in the connection end face 11a of each ferrule 10, and the end face of the optical fiber 2 is exposed in the fiber hole 13. The end faces of the optical fibers 2 are brought into contact with or close to each other along with the contact between the connection end faces 11a, whereby the optical fibers 2 of the optical connectors 1A and 1B are optically connected. Since the ferrules 10 are pressed against one another by an appropriate pressing force (magnetic force), the optical connection state is stabilized.

As described above, the ferrule 10 of one or more embodiments includes the body portion 11 having the fiber hole 13 through which the optical fiber 2 is inserted through and the connection end face 11a at which the fiber hole 13 opens. Then, the body portion 11 has a substance (permanent magnet 16) that generates a magnetic force therein, and is configured to optically connect the optical fiber 2 to another optical fiber 2 by the magnetic force. In this way, by abutting the connection end faces 11a of the ferrules 10 against one another using a magnetic force, it is possible to suppress abrasion of the ferrules 10 compared to the case where a clip or the like is used, for example.

Further, the body portion 11 includes the guide hole 12 for the guide pin 20, which extends along the axial direction of the fiber hole 13 and opens at the connection end face 11a, and an accommodating portion 15 for accommodating the substance, and the substance is a permanent magnet 16. Thus, the magnetic force generated by the permanent magnet 16 is able to attract the ferrules 10 to one another and optically connect the optical fibers 2 to one another.

In one or more embodiments, the body portion 11 may be formed of a material containing a hard magnetic filler or a soft magnetic filler. When the body portion 11 contains a soft magnetic filler, the permanent magnet 16 magnetizes the soft magnetic filler in the body portion 11. Thereby, a magnetic pole is able to be given to the connection end face 11a. In this way, by generating not only the magnetic force via the guide pin 20 but also the magnetic force acting between the connection end faces 11a, the attraction force between the ferrules 10 increases, and it is possible to make the connection state between the optical fibers 2 more stable.

The optical connector 1A of one or more embodiments includes the ferrule 10, the guide pin 20 inserted through the guide hole 12 and protruding from the connection end face 11a, and the optical fiber 2 inserted through the fiber hole 13, and the guide pin 20 is formed of a soft magnetic material. When the connection end face 11a side in the axial direction is defined as a front side and an opposite side of the connection end face 11a side is defined as a rear side, the accommodating portion 15 is positioned to the rear side of the guide hole 12. According to such a configuration, the guide pin 20, which is a soft magnetic material, is magnetized even when the accommodating portion 15 and the permanent magnet 16 are disposed away from the connection end face 11a. When the male optical connector 1A is connected to the female optical connector 1B, the permanent magnet 16 of the male optical connector 1A and the permanent magnet 16 of the female optical connector 1B attract one another through the guide pin 20. Therefore, the ferrules 10 is able to be attracted to one another by the magnetic force.

It should be noted that the technical scope of the present invention is not limited to the above-described embodiments, and various modifications can be made.

For example, the shape of the ferrule 10 in the first and second embodiments is merely an example. The shape of the ferrule 10 may be changed appropriately according to the specific types and standards of the optical connectors 1A and 1B.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

1A, 1B: Optical Connector
2: Optical Fiber
10: Ferrule
11: Body Portion
11a: Connection End Face
12: Guide Hole
13: Fiber Hole
15: Accommodating Portion
16: Permanent Magnet
20: Guide Pin

1. A ferrule for an optical connector comprising:
a body portion including:
a fiber hole through which a first optical fiber is inserted;
a connection end face at which the fiber hole opens; and
a substance, within the body portion, that generates a magnetic force, wherein
the body portion is configured to optically connect the first optical fiber to a second optical fiber by the magnetic force.

2. The ferrule according to claim 1, wherein
the body portion is formed of the substance, which is a material containing a hard magnetic filler, and
the magnetic force acts on the connection end face.

3. An optical connector comprising:
the ferrule according to claim 1;
the first optical fiber inserted through the fiber hole; and
a guide pin, wherein
the body portion further has a guide hole that extends along an axial direction of the fiber hole and that opens at the connection end face, and
the guide pin:
is inserted through the guide hole,
protrudes from the connection end face, and
is formed of a non-magnetic material.

4. The ferrule according to claim 1, wherein
the body portion further includes:
a guide hole for a guide pin;
an accommodating portion in which the substance is accommodated,
the guide hole extends along an axial direction of the fiber hole and opens at the connection end face, and
the substance is a permanent magnet.

5. The ferrule according to claim 4, wherein the body portion is formed of a material containing a hard magnetic filler or a soft magnetic filler.

6. An optical connector comprising:
the ferrule according to claim 4;
a guide pin that:
is inserted through the guide hole,
protrudes from the connection end face, and
is formed of a soft magnetic material; and
a first optical fiber inserted through the fiber hole, wherein
when a side of the connection end face in the axial direction is defined as a front side and an opposite side of the side of the connection end face is defined as a rear side, the accommodating portion is positioned to the rear side of the guide hole.
